(19) United States
(12) Patent Application Publication
(10) Pub. No.: US 2026/0169444 A1
(43) Pub. Date: Jun. 18, 2026

(54) CONFIGURABLE METHOD FOR DYNAMIC BOUNDARY MANAGEMENT WITH ADAPTIVE ANCHORING

(71) Applicant: SONY GROUP CORPORATION, Tokyo (JP)

(72) Inventors: Siddhant Gangapurwala, Seattle, WA (US); Neil Burch, Edmonton (CA)

(21) Appl. No.: 18/982,356

(22) Filed: Dec. 16, 2024

(51) Int. Cl. G05B 13/02

(52) U.S. Cl. CPC G05B 13/0265

(57) ABSTRACT

A system and method dynamically manages the operational boundaries of an autonomous system or agent in a configurable and adaptable manner. Traditional approaches rely on static or fixed boundaries to constrain an agent's operation, which can be highly restrictive and inefficient. To address these issues, a virtual anchor state is established to provide a dynamic reference entity that represents a focal point based on factors such as proximity to objectives, environmental conditions, or system priorities. The agent state provides real-time information such as the agent's position, status, and behavior, while environmental data includes external factors like obstacles, nearby objects, or mission-specific variables. By combining these inputs, the system continuously updates the anchor state to reflect the most relevant context and uses it to calculate boundary conditions, which define permissible operational areas or constraints. These boundaries adapt dynamically to changing contexts, such as shifts in the environment or agent behavior.

### BACKGROUND OF THE INVENTION

### 1. Field of the Invention

Embodiments of the invention relate generally to systems and methods of managing operational boundaries and constraints of controllable systems or processes, including autonomous systems and artificial intelligent (AI) agents. More particularly, embodiments of the invention relate to methods and systems for allowing a controllable systems or processes to dynamically manage its operational boundaries and constraints in an adaptable, configurable way, using a virtual “anchor point” that is continuously updated based on criteria that can be tailored to the specific needs of each application or environment.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In a conventional approach, fixed boundaries are set to constrain the operation of an autonomous system or an artificial intelligent (AI) agent, limiting its ability to perform tasks effectively. In a navigation domain, the system may involve the agent navigating from one location to another during a mission. In such cases, boundaries are often defined to force the agent to follow a specific predefined path while remaining within a certain distance from the path, thereby constraining the agent's motion. For each starting position, a unique path must be defined, which is impractical for complex environments with numerous starting points and target locations. At each location, fixed boundaries would restrict the agent's operation to a predefined area around the target. If the goal target moves outside of this boundary, the agent would be unable to follow, as the static boundary would constrain the agent's behavior. This failure to adapt to a moving target reduces the system's effectiveness and significantly limits the agent's ability to pursue dynamic objectives, diminishing both realism and adaptability. Furthermore, in scenarios involving multiple navigation tasks, defining fixed boundaries manually for every potential combination of starting position and target location is time-consuming and infeasible. This challenge is especially pronounced in environments with infinitely many possible initial positions and target placements, making it impractical to predefine and manage all boundary conditions.

In view of the foregoing, there is a need for improved systems and methods for dynamic boundary management.

### SUMMARY OF THE INVENTION

Embodiments of the present invention provide a method for dynamically managing operational boundaries and constraints of a controllable systems or processes comprising identifying and selecting anchor criteria to determine when and how an anchor state of the controllable systems or processes is updated; initializing the anchor state based on initial conditions and objectives of the controllable systems or processes; assessing whether current conditions of the controllable systems or processes still satisfy the anchor criteria; if the current conditions fail to satisfy the anchor criteria, updating the anchor state to reflect changes; and calculating boundary condition that defines permissible boundaries for the controllable systems or processes based on the anchor state.

In some embodiments, which may be combined with the above embodiment, the method further comprises checking if a current position or state of the controllable systems or processes deviates from the permissible boundaries defined by the boundary condition; and if the deviation of the controllable systems or processes relative to the anchor state exceeds a configurable threshold, the method triggers an appropriate response.

In some embodiments, which may be combined with any of the above embodiments, the response may include one or more of the following: terminating the operation of the controllable systems or processes, issuing an alert, or initiating a recalibration process.

In some embodiments, which may be combined with any of the above embodiments, the method further comprises operating the method in a continuous loop, with each iteration dynamically adjusting the anchor state and the boundary condition as new data is received by the controllable systems or processes.

In some embodiments, which may be combined with any of the above embodiments, the anchor criteria are based on one or more measurable parameters, including one or more of a proximity to a target, a resource level, a time-based trigger, or a milestone completion.

In some embodiments, which may be combined with any of the above embodiments, the controllable systems or processes is an autonomous vehicle; and the anchor criteria include proximity to a fuel station.

In some embodiments, which may be combined with any of the above embodiments, the controllable systems or processes is an industrial system; and the anchor criteria include a production metric or a system alert.

In some embodiments, which may be combined with any of the above embodiments, the controllable systems or processes is a character in a video game; and the anchor criteria include proximity of the video game character to another character or target in the video game.

In some embodiments, which may be combined with any of the above embodiments, the anchor state includes an anchor value defining a starting reference point or value relevant to the anchor criteria, as well as reference target data defining a goal, target, or contextual data to which the anchor criteria are currently coupled or associated.

In some embodiments, which may be combined with any of the above embodiments, the boundary condition defines an allowable operational area for the controllable systems or processes.

Embodiments of the present invention provide a method for training an autonomous agent to interact in a video game, comprising: identifying and selecting anchor criteria to determine when and how an anchor state of the autonomous agent is updated; initializing the anchor state based on initial conditions and objectives of the autonomous agent; calculating boundary condition that defines an allowable operational area for the autonomous agent based on the anchor state; assessing whether current conditions of the autonomous agent still satisfy the anchor criteria; and if the current conditions fail to satisfy the anchor criteria, updating the anchor state to reflect changes.

Embodiments of the present invention provide a system for dynamically managing operational boundaries and constraints of a controllable systems or processes comprising an anchor management module receiving agent state information and environment data to determine an anchor state; a boundary management module receiving data including the agent state information, the environment data, and the determined anchor state to generate a boundary condition; and a boundary enforcement module using data including the agent state information, the environment data, and the boundary condition to provide agent behavior control.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an overview of dynamic boundary management with adaptive anchoring, according to exemplary embodiments of the present invention;

FIG. 2 illustrates a target prioritization use case of a controllable entity for the dynamic boundary management system of FIG. 1, showing an initialization of the anchor state, according to an exemplary embodiment of the present invention;

FIG. 3 illustrates a target prioritization use case for the dynamic boundary management system of FIG. 1, showing a state when the first target is reached or completed, according to an exemplary embodiment of the present invention;

FIG. 4 illustrates a target prioritization use case for the dynamic boundary management system of FIG. 1, showing a state when the AI agent moves toward a reference target, according to an exemplary embodiment of the present invention;

FIG. 5 illustrates a target prioritization use case for the dynamic boundary management system of FIG. 1, showing a state when the AI agent moves away from a reference target, according to an exemplary embodiment of the present invention;

FIG. 6 illustrates a target prioritization use case for the dynamic boundary management system of FIG. 1, showing a state when the AI agent moves away from a reference target beyond a boundary condition, according to an exemplary embodiment of the present invention; and

FIG. 7 provides a functional block diagram illustration of a computer hardware platform that can be used to implement a particularly configured computing device that can perform dynamic boundary management, as herein described.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and/or textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As used herein, an “anchor state” is a dynamic entity that serves as a reference or focal point for managing the agent's operational boundaries and constraints. Unlike a static anchor, the anchor state is designed to be adaptive, moving or changing in response to the environment based on configurable rules. These rules dictate when and how the anchor state should be updated, allowing for flexible boundary management. An anchor state may include the following: (1) An anchor point, which is the specific position that acts as the center of the agent's operational boundaries and constraints; (2) a reference-target, which is the environmental or situational target to which the anchor is attached, such as the closest target or object of interest. This can change dynamically as the situation evolves; and (3) additional relevant data, which includes any other data needed to adjust the anchor according to the rules, such as proximity thresholds, target type, or priority.

As used herein, “boundary condition” refers to a set of criteria evaluated relative to the anchor state, which determines the agent's allowable scope of operation.. When the boundary condition is evaluated, it generates an output that may trigger specific actions, such as boundary adjustments, alerts, or other responses. As the agent interacts with its environment, the boundary condition can adapt dynamically, expanding, contracting, shifting, or remaining constant based on the anchor state and the agent's context.. This creates a flexible “allowable operational scope” that adapts to changes and remains relevant to the agent's context.

As used herein, “configurable criteria” refers to the criteria for updating the anchor state and managing boundaries, which are configurable, allowing users to define which factors influence boundary adjustments and when these adjustments occur. These criteria can be tailored to suit various operational needs. For instance, they might rely on proximity to specific targets, changes in environmental conditions, or objectives directly related to the agent's task. Additionally, these criteria can be set to either dynamic or static modes. With dynamic criteria, boundary conditions or anchor states change adaptively based on real-time factors, such as agent's distance to the anchor, environmental changes, or agent state. With static criteria, the boundary conditions or anchor states remain consistent, generating the same boundary parameters regardless of changes in the anchor state or environmental context.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a system and method that dynamically manages the operational boundaries of an autonomous system or agent in a configurable and adaptable manner. Traditional approaches rely on static or fixed boundaries to constrain an agent's operation, which can be highly restrictive and inefficient. These fixed boundaries often fail to adapt to dynamic environments, such as changing target locations or evolving mission objectives, limiting the agent's ability to respond effectively. Additionally, manual configuration of such boundaries for complex systems—especially those with infinite or highly variable starting conditions—is time-consuming and infeasible. To address these limitations, embodiments of the present invention introduce a virtual anchor state, a dynamic reference entity that represents a focal point based on factors such as proximity to objectives, environmental conditions, or system priorities. The agent state provides real-time information such as the agent's position, status, and behavior, while environmental data includes external factors like obstacles, nearby objects, or mission-specific variables. By combining these inputs, the system continuously updates the anchor state to reflect the most relevant context and uses it to calculate boundary conditions, which define permissible operational areas or constraints. These boundaries adapt dynamically to changing contexts, such as shifts in the environment or agent behavior. By enabling real-time boundary adjustment, the method overcomes the rigidity of static boundaries, improving the agent's ability to learn, adapt, and operate efficiently in diverse domains, including robotics, navigation, industrial systems, and game AI.

In reinforcement learning frameworks for game agents, comprising AI agents operating in virtual environments, systems and methods according to embodiments of the present invention can be used to manage the agent's operational boundaries in dynamic scenarios, such as combat or traversal tasks. For example, an AI agent tasked with engaging multiple groups of enemies scattered across a large environment might struggle to prioritize targets or remain focused on relevant combat areas. Without guidance, the AI agent would need to explore the entire environment to locate relevant enemies or combat objectives, potentially resulting in extensive exploration time and a high likelihood of failing to engage effectively with the intended tasks. Without a system to dynamically manage boundaries, the agent could spend excessive time wandering aimlessly or engaging in irrelevant actions, leading to inefficient learning and poor task performance. By dynamically managing boundaries based on real-time criteria, such a system improves the training process for reinforcement learning agents, enabling them to learn more efficiently by focusing on relevant tasks and reducing unnecessary exploration.

Instead of allowing unrestricted exploration or relying on static boundaries, the present methods dynamically adjust the operational boundaries of the combat game agent based on its interactions with the environment, particularly with respect to the closest enemies or combat objectives. This adaptive boundary management enables the agent to focus on relevant areas, improving its ability to engage effectively with combat scenarios and optimizing both training efficiency and learning outcomes.

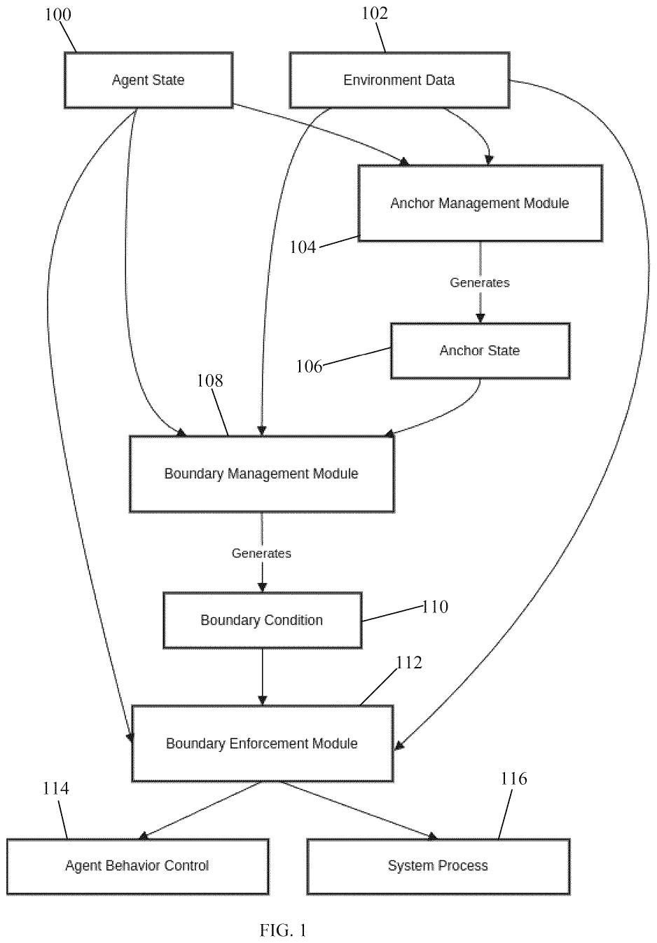

Referring to FIG. 1, an overview of dynamic boundary management with adaptive anchoring, according to exemplary embodiments of the present invention, is illustrated. Agent state data 100 and environment data 102 can be provided to an anchor management module 104. As described in greater detail below, the anchor management module 104 can generate the anchor state 106. A boundary management module 108 can receive agent's state data 100, the environment data 102 and the anchor state 106 to generate a boundary condition 110, as described in greater detail below. A boundary enforcement module 112 can use the agent state data 100, the environment data 102 and the boundary condition 110 to provide agent behavior control 114 and other system processes 116.

An anchor state is initially selected based on a set of configurable criteria, such as proximity to relevant objects, specific targets, or obstacles in the environment. For instance, in a game, the anchor might be set with a reference target given by the closest opponent to focus the player's attention on that target. In a robotics context, the anchor's reference target could be set to the closest waypoint or object of interest, guiding the robot's movement relative to this reference.

As the agent operates in its environment, the anchor state is continuously monitored and updated. The configurable criteria determine when and how updates occur. For example, if a new target becomes closer or more relevant, the anchor's reference-target can shift to reflect this new priority, ensuring the agent's operational boundaries and constraints remain relevant to the current context.

The boundary condition refers to a set of criteria used to define the agent's allowable operational area, which is determined based on the current anchor state and relevant environmental factors. When evaluated, these criteria determine whether the boundary should expand, contract, or shift dynamically in response to changes in the anchor state or the environment. As the agent interacts with its surroundings, the boundary condition continuously adapts, maintaining a flexible and context-aware operational scope that is responsive to both environmental and agent-driven changes.

The boundary adjusts dynamically based on the agent's proximity or relationship to the anchor state. For example, when the agent moves closer to the anchor's reference target, the boundary can be relaxed, allowing the agent more flexibility to explore the vicinity of the reference target. Conversely, when the agent moves further from the anchor state, the boundary may contract, ensuring the agent remains within a controlled area and does not drift too far from the reference target.

The boundary enforcement module monitors the agent's state relative to the defined boundary condition. This module also enforces configurable threshold conditions. For instance, if the agent exceeds a set limit or moves too far from the anchor state, boundary enforcement actions are triggered. Once a boundary is enforced, it influences the agent's behavior by restricting or guiding its operation. For example, if an autonomous traversal agent breaches the allowable boundary, it might be prompted to realign with the anchor state or adjust its path to remain within acceptable limits. Within a game environment, if a player exceeds a boundary threshold, this system can trigger a reset mechanism to force a player to stay within the boundary regions.

The entire process repeats continuously, adapting to any changes in the environment, agent position, or configurable criteria.

### Example

The methods of the present invention address limitations of conventional approaches, such as using fixed boundaries to constrain the behavior of a game agent controlling the playable “main character” in a combat scenario of a video game during reinforcement learning. In such a scenario, the main playable character is tasked with engaging multiple enemies distributed across a large game environment. A conventional system might rely on static, predefined boundaries or paths, which restrict the main character's ability to pursue dynamic objectives, such as moving enemies, and require extensive manual configuration. The present method, however, dynamically manages boundaries around the main character in real-time based on configurable rules, allowing the agent to adaptively engage targets and maintain context-appropriate constraints without the need for rigid or static boundaries.

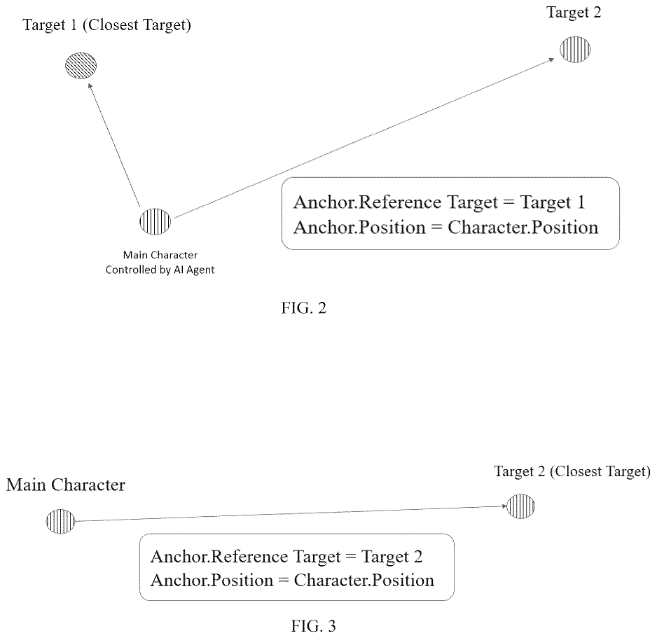

Initialization of Anchor State. Referring to FIG. 2, the anchor state is initially set with main character's current position as the anchor point. The reference target for the anchor is determined as the closest enemy relative to main character's position, ensuring that the boundary is centered around the most immediate combat objective.

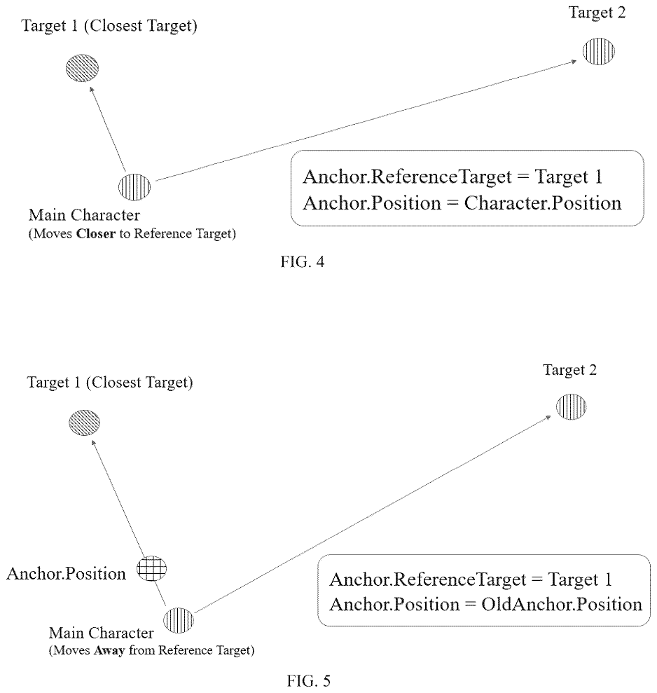

Anchor State Updates During Combat. The anchor state continuously updates based on main character's actions and environmental changes. If the main character moves away from the current closest enemy or if that enemy is defeated and disappears (as shown in FIG. 3, for example), the anchor's reference target is updated to the new closest enemy. If the nearest target changes, the anchor point is reset to the main character's current position, ensuring the boundary remains relevant to his immediate context. If the closest enemy remains the same and the main character moves closer to this enemy, as shown in FIG. 4, the anchor point is updated to its new position. This adjustment ensures that the boundary shifts to remain centered around the main character's new location while maintaining its original size, keeping the engagement area focused on the target. If the main character moves away from the closest enemy without a new enemy becoming closer, as shown in FIG. 5, the anchor point remains unchanged. This prevents the boundary from expanding unnecessarily, encouraging the main character to re-engage the closest target without drifting too far.

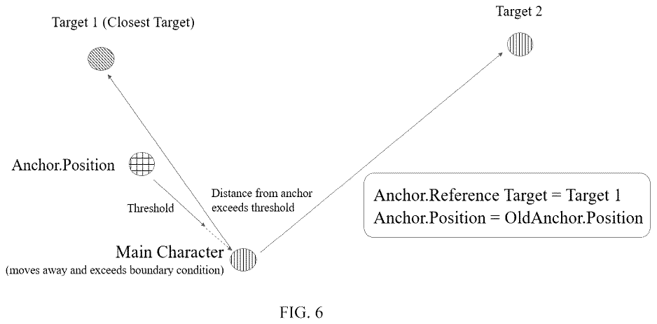

If the main character's distance from the anchor point exceeds a configurable threshold (e.g., 50 meters), as shown in FIG. 6, the training episode terminates, and a significant penalty is applied. There's also a possibility for this threshold to vary dynamically based on the main character's distance from the reference target, such that the threshold is reduced if the main character's distance to the closest enemy is large, ensuring that the main character focuses on the objective of approaching the target. This enforcement is managed by the boundary management module.

### Benefits of Using Dynamic Boundary Management System with Adaptive Anchoring (DBAA) in Reinforcement Learning

Efficient Learning. By keeping the main character's boundaries adaptive and relevant to his immediate context, the methods of the present invention prevent unnecessary exploration, allowing the agent to focus on learning combat interactions.

Scalability and Flexibility. With the methods of the present invention, there is no need to define fixed boundaries or paths manually. The main character can start from any location, and enemies can be placed in any position, allowing for infinite initial configurations without additional setup.

Dynamic Pursuit. Since DBAA does not impose fixed bounding regions, the main character can pursue a moving enemy if it drifts outside the initial engagement area. This makes the AI agent's behavior more realistic and better suited for dynamic combat scenarios.

This entire sequence—updating the anchor state based on configurable criteria, adjusting the boundary condition, and enforcing boundaries—is repeated continuously as the main character navigates and engages with enemies. This ongoing adaptation allows the agent to handle complex scenarios where enemy positions, movement patterns, and environmental contexts are always changing.

Aspects of the present invention can provide advantages in game design and reinforcement learning, including the following: (1) Adaptive boundary control, where, unlike fixed boundaries, aspects of the present invention allow boundaries to adapt in real-time, responding to shifts in the environment and maintaining flexibility; (2) Enhanced learning efficiency, where, by terminating episodes when thresholds are exceeded, the methods enable the agent to focus on meaningful interactions rather than random exploration; (3) Scalable and configurable design, where the methods remove the need for manual boundary definitions, accommodating infinitely variable starting points and enemy positions without extra configuration; and (4) Realistic agent behavior, as the dynamic boundary adjustment allows agents, like playable gaming characters, to pursue moving targets naturally, making behavior more realistic and responsive to context.

Methods, according to embodiments of the present invention, provide a versatile approach and can be adapted to various domains by abstracting the concept of an “anchor” and boundary criteria to suit other types of data, inputs, and objectives. Some examples of broader applications include the following: (1) Active player areas for multi-part game missions. In video games involving multi-part missions, methods of the present invention can be used to define active player areas that adapt as the mission progresses. The initial anchor position can be set based on the first task objective, and position updates can occur as the player completes tasks and advances to subsequent stages. This ensures that boundaries remain relevant and support the player's objectives throughout the game. (2) Resource management in industrial processes. In manufacturing or industrial automation, methods of the present invention can help guide robotic arms or automated systems by adjusting anchors based on production metrics or resource levels. This dynamic approach can ensure optimal operation by adapting to changing conditions on the assembly line. (3) Autonomous vehicle navigation. For self-driving cars or drones, anchors could be set relative to refueling stations, traffic conditions, or delivery points. Boundaries adjust in response to dynamic factors like traffic or battery levels to maintain efficient routing and safety. (4) Environmental monitoring. in environmental applications, methods of the present invention can be used to direct monitoring agents to areas of interest based on data such as pollution levels, temperature, or weather anomalies. The anchor would shift dynamically to focus on significant environmental changes, ensuring resources are allocated efficiently. (5) Robotic navigation. In robotic navigation, methods of the present invention can be utilized to create adaptable movement boundaries that respond to changing conditions such as target locations, obstacles, or route priorities. For example, an autonomous delivery robot navigating a complex warehouse can use methods of the present invention to dynamically adjust its operational area as it encounters new obstacles, shifts in task objectives, or updated delivery points. This enables the robot to navigate efficiently without relying on static, pre-defined paths and ensures it can adapt in real-time to optimize its route and performance.

In the methods of the present invention, the “anchor” need not be limited to a physical location or spatial reference point. Instead, it can represent any abstract entity based on relevant factors in the agent's environment. Some examples of abstract anchors include the following: (1) Time-based anchors, where anchors adjust based on elapsed time or specific time-based conditions; (2) Resource-based anchors, where anchors are tied to resource levels (e.g., energy, fuel, or bandwidth) that trigger boundary updates as resources are consumed or replenished; (3) Performance-based objectives, where anchors reflect progress toward a goal, such as task completion percentage, success rates, or performance metrics; and (5) Environmental conditions, where anchors are linked to environmental readings like temperature, pressure, pollution levels, or other sensor data in real-time applications.

The criteria for updating the anchor and managing boundaries are fully configurable, allowing users to define any measurable function relevant to the agent's objectives. Examples of configurable criteria include the following: (1) Resource thresholds, where the anchor is updated when the agent's resources (e.g., fuel, power) drop below a certain threshold, triggering a recalibration of movement or boundary constraints; (2) Performance metrics, where the anchor is adjusted based on achievement of performance milestones, such as percentage of a task completed; (3) Dynamic event detection, where conditions are set for anchor updates in response to new events or signals (e.g., emergency alerts, detected obstacles); and (4) Heuristic functions, where custom functions or heuristics are allowed to dictate the update frequency or direction of the anchor, making DBAA adaptable to highly specific requirements.

Adaptive boundary conditions could be based on, for example, any one or more of the following: (1) Resource availability, where expanding or contracting boundaries depend on available resources, like adjusting an autonomous vehicle's range based on fuel levels; (2) Environmental dynamics, where modifying boundaries is based on changing environmental readings, like adjusting permissible movement areas for a drone based on wind speed; and (3) Progress-based adaptation, where boundaries are contracted or expanded as the agent approaches or deviates from a target or completion point in a task.

### Generic Algorithm Steps

The following generic steps outline how the methods of the present invention can be implemented across various domains, replacing distance-based criteria with more general, configurable parameters.
Step 1: Define Anchor Criteria. Identify and select the criteria that will determine when and how the anchor state is updated. Criteria can be based on various measurable parameters such as proximity to a target, resource levels, time-based triggers, or completion milestones. For an autonomous vehicle, for example, the anchor criteria might be based on proximity to fuel stations. In an industrial setting, for example, the criteria could be based on production metrics or system alerts.
Step 2: Set Initial Anchor State. Initialize the anchor state based on the agent's initial conditions and objectives. The initial anchor state includes the following: (1) Anchor value, which is the starting reference point (or value) relevant to the criteria; (2) Reference target, which is the goal, target, or contextual data to which the anchor is currently attached; and (3) Additional relevant data, which is any other required information that influences boundary adjustments, such as priority levels or environmental conditions.
Step 3: Continuous Monitoring. At each time step, assess whether the current conditions still satisfy the anchor criteria. If the conditions have changed (e.g., a new target appears, resource levels drop), update the anchor state to reflect these changes. In a resource-monitoring context, for example, if fuel levels drop below a certain threshold, the anchor could reset to a refueling station. In an environmental monitoring system, for example, if pollution levels spike, the anchor could shift to focus on the affected area.
Step 4: Boundary Calculation and Adjustment. Based on the updated anchor state, calculate the boundary condition that defines the allowable operational area for the agent. Adjust boundaries dynamically, based on the agent's proximity to the anchor (if applicable), resource levels, time constraints, or other context-relevant data. For a drone in a weather-sensitive application, for example, boundaries could expand in calm weather and contract in windy conditions. For a delivery robot, for example boundaries might adjust based on distance from a target or priority level of nearby tasks.
Step 5: Boundary Enforcement and Response Trigger. Check if the agent's current position or state deviates from the permissible boundaries defined by the boundary condition. If the agent's deviation from the anchor exceeds a configurable threshold, trigger an appropriate response, such as one or more of the following (1) Terminate: In a learning application, the episode might terminate if the agent strays too far from the boundary; (2) Alert: In a monitoring system, alerts may notify the agent or operator if thresholds are crossed; and/or (3) Recalibration: Adjust the agent's operational parameters, such as speed or resource usage, to realign it with the anchor. An autonomous vehicle, for example, could receive a rerouting command if it exceeds boundary limits due to traffic or weather changes. In a health-monitoring robot, for example, an alert might trigger when vital signs indicate the patient has moved outside acceptable ranges.
Step 6: Continuous Re-evaluation. This entire process operates in a continuous loop, with each iteration dynamically adjusting the anchor, boundary conditions, and boundary enforcement as new data is provided to the system.

### Example Computer Platform

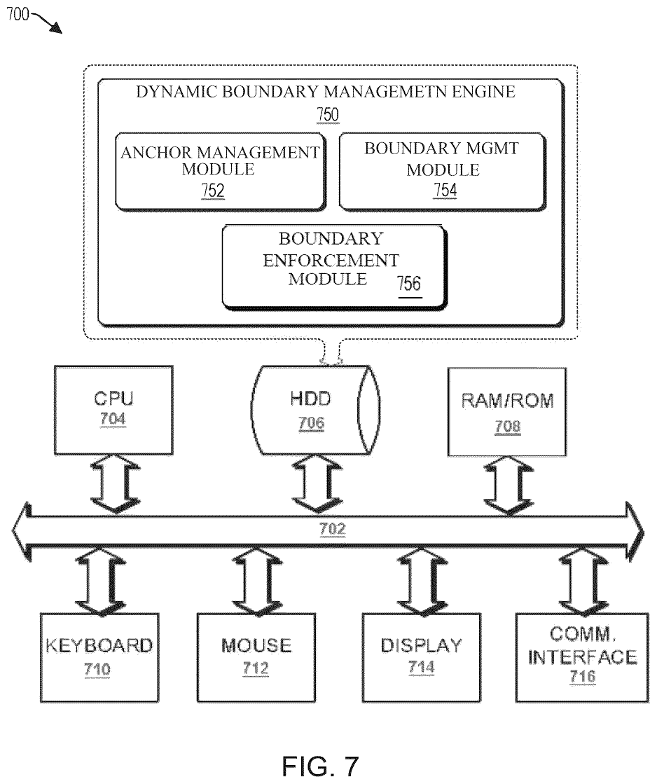

FIG. 7 provides a functional block diagram illustration of a computer hardware platform 700 that can be used to implement a particularly configured computing device that can provide a dynamic boundary management engine 750. The dynamic boundary management engine 350, as discussed above, can include an anchor management module 752, a boundary management module 754 and a boundary enforcement module 756.

The computer platform 700 may include a central processing unit (CPU) 702, a hard disk drive (HDD) 704, random access memory (RAM) and/or read only memory (ROM) 706, a keyboard 708, a mouse 710, a display 712, and a communication interface 714, which are connected to a system bus 716.

In one embodiment, the HDD 704, has capabilities that include storing a program that can execute various processes, such as the dynamic boundary management engine 750, in a manner to perform the methods described herein.

Of course, the methods of the present invention may be carried out by various computing devices, including the computer hardware platform 700, described above, or may further be performed in a cloud computing system having resources for providing the dynamic boundary management system as discussed herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for dynamically managing operational boundaries of a controllable system or process, comprising:
generating an anchor state based on agent state data and environment data using an anchor management module;
calculating a boundary condition using the anchor state, the agent state data, and the environment data via a boundary management module;
assessing whether the current state of the controllable system or process satisfies the boundary condition; and
dynamically updating the anchor state and/or the boundary condition based on changes in the agent state data or the environment data.

2. The method of claim 1, further comprising:
checking if the controllable system or process deviates from permissible boundaries defined by the boundary condition; and
if a deviation of the controllable system or process from the anchor state exceeds a configurable threshold, triggering a response.

3. The method of claim 2, wherein the response includes one or more of the following:
enforcing an adjustment to a behavior of the controllable system of process to comply with the boundary condition;
issuing an alert to indicate a violation; or
recalibrating the controllable system or process to adapt to the deviation.

4. The method of claim 1, further comprising operating the method in a continuous loop, with each iteration dynamically adjusting the anchor state and the boundary condition as new data is received by the controllable system or process.

5. The method of claim 1, wherein the boundary condition defines a set of parameters to evaluate an agent's operational area, including proximity to targets, resource usage, time constraints, or task completion metrics.

6. The method of claim 5, wherein:
the controllable system or process is an autonomous vehicle; and
the boundary condition includes proximity to a refueling station or waypoint.

7. The method of claim 5, wherein:
the controllable system or process is an industrial system; and
the boundary condition includes production metrics or system alerts.

8. The method of claim 5, wherein:
the controllable system or process is a character in a video game; and
the boundary condition includes proximity of a playable video game character to other in-game targets, objectives, or other characters.

9. The method of claim 1, wherein the anchor state includes:
an anchor point representing a dynamic reference parameter relevant to an agent's operational context; and
contextual data used to adapt the anchor state based on environmental changes.

10. The method of claim 1, wherein the boundary condition dynamically adjusts an operational area of the controllable system or process based on the anchor state, the agent state data, and the environment data.

11. A method for training an autonomous agent to interact in a video game, comprising:
receiving agent state data and environment data as inputs to generate an anchor state via an anchor management module;
calculating a boundary condition based on the anchor state, the agent state data, and the environment data via a boundary management module;
monitoring a state of the autonomous agent relative to the boundary condition via a boundary enforcement module;
triggering corrective actions if the boundary condition is violated; and
continuously updating the anchor state and the boundary condition during training based on changes in the agent state data and the environment data.

12. The method of claim 11, further comprising:
evaluating the boundary condition to determine whether an agent's operational state deviates from acceptable parameters; and
if the deviation of the autonomous agent from the anchor state exceeds a configurable threshold, triggering a response.

13. The method of claim 12, wherein the response includes terminating the training episode, issuing a penalty or reward, or adjusting agent operational parameters to ensure compliance with the boundary condition.

14. The method of claim 11, further comprising operating the method in a continuous loop, with each iteration dynamically adjusting the anchor state and the boundary condition as new data is received by the autonomous agent.

15. The method of claim 11, wherein the anchor state data includes an anchor point representing a dynamic reference for managing an agent's focus, and additional contextual data for adapting to environmental changes, including a proximity to a target.

16. The method of claim 11, wherein the boundary condition defines a set of parameters that evaluate an agent's performance relative to task objectives, proximity to targets, or operational constraints.

17. A system for dynamically managing operational boundaries of a controllable system of process, comprising:
an anchor management module receiving state information and environment data to determine an anchor state;
a boundary management module receiving data including the state information, the environment data, and the determined anchor state to generate a boundary condition; and
a boundary enforcement module using data including the state information, the environment data, and the boundary condition to evaluate a state of the controllable system or process relative to the boundary condition and enforce actions to guide or constrain behavior of the controllable system of process.

18. The system of claim 17, wherein the boundary enforcement module is configured to:
check if a current state of the controllable system or process deviates from an allowable operational area defined by the boundary condition; and
if the deviation of the controllable system or process from the anchor state exceeds a configurable threshold, triggering a response, including realigning the behavior of the controllable system or process, issuing alerts, or recalibrating the controllable system or process.

19. The system of claim 17, wherein the system operates continuously to dynamically adjust the anchor state and the boundary condition as new state data and new environment data are received.
